(19) United States
(12) Patent Application Publication
(10) Pub. No.: US 2015/0332535 A1
(43) Pub. Date: Nov. 19, 2015

(54) Identity check glove

(71) Applicants: Leroy Doctor, Rochester, NY (US); Lehana Doctor, Rochester, NY (US)

(72) Inventors: Leroy Doctor, Rochester, NY (US); Lehana Doctor, Rochester, NY (US)

(21) Appl. No.: 14/713,073

(22) Filed: May 15, 2015

Related U.S. Application Data
(60) Provisional application No. 61/994,337, filed on May 16, 2014.

(51) Int. Cl. G07D 7/12; A41D 19/00

(52) U.S. Cl. CPC G07D 7/121; A41D 19/0024

(57) ABSTRACT

An identity check glove provides battery-powered light-emitting diodes (LEDs) in the thumb which emit black light. The black light is used to check the authenticity of government issued identification cards, passports, and similar documents. Friction coating is provided on the thumb and forefinger to prevent important documents from slipping through the user's grasp.

### CROSS-REFERENCE TO RELATED APPLICATIONS

This Application claims the benefit of U.S. Provisional Application No. 61/994,337, filed May 16, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to security devices, and in particular to an identity check glove. The creation of false identification cards is a growing industry. Illegal aliens, minors engaged in the unlawful consumption of alcohol, and criminals seeking to avoid arrest on outstanding arrest warrants are only a few of the types of customers seeking fake identifications (IDs), and the supply meeting this demand is growing more technologically sophisticated. Fortunately, government agencies charged with the issuance of ID cards, passports, and similar documents are developing improved countermeasures to defeat the forgery industry. One such countermeasure is a seal or other security indicator, which reacts to ultraviolet light and changes appearance when placed under a black light. Due to the nature of many security checkpoints, particularly in taverns and nightclubs, a hand-held black light projector would be very useful to check the authenticity of identification cards. An identity check glove, which provides a black light from battery-powered light-emitting diodes (LEDs), would resolve this problem.

### SUMMARY OF THE INVENTION

Accordingly, the invention is directed to an identity check glove. The glove provides battery-powered light-emitting diodes (LEDs) in the thumb which emit black light. The black light is used to check the authenticity of government issued identification cards, passports, and similar documents. Friction coating is provided on the thumb and forefinger to prevent important documents from slipping through the user's grasp.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

FIG. 1 is a front perspective view of the first exemplary embodiment worn on the user's hand, displaying the glove 10, the LEDs 11, and the friction coating 12.

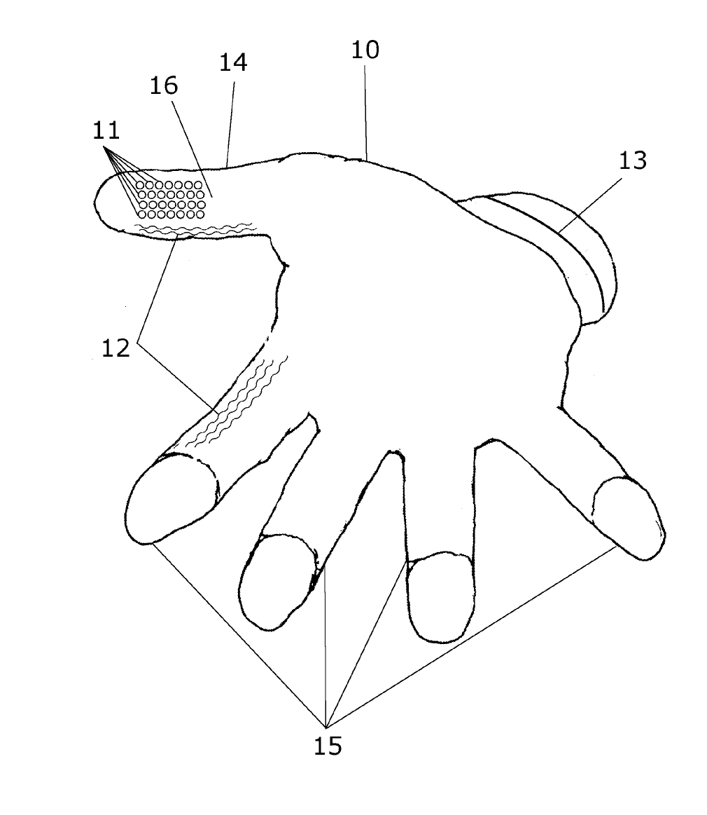

### DETAILED DESCRIPTION OF THE INVENTION

Referring now to the invention in more detail, the invention is directed to an identity check glove 10. The glove having a thumb 14 and a plurality of fingers 15. The glove 10 provides battery-powered light-emitting diodes (LEDs) 11 in the thumb 14 which emit ultra-violate light. The ultra-violate light is used to check the authenticity of government issued identification cards, passports, and similar documents. Friction coating 12 is provided on the thumb 14 and index finger to prevent important documents from slipping through the user's grasp.

Preferably, the tips of the four fingers 15 are uncovered such that the user may retain full tactile sensitivity. The glove 10 provides a pressure activated on/off switch 16 in the thumb 14, adjacent to the LEDs 11, and a small battery compartment in the wrist 13 containing one or more replaceable batteries. The LEDs 11 and the on/off switch 16 are electrically connected to the batteries via wires. Gloves 10 are sold individually in assorted sizes and in two models, for right-handed and left-handed users. Preferably, the user will wear the glove 10 on the non-dominant hand. All electrical components are easily removed and replaced as a single assembly, enabling the user to launder the glove 10.

To use the first exemplary embodiment, the user places the glove 10 on the non-dominant hand. When checking identification, the user may press the on/off switch 16 to activate the LEDs 11. The user holds the ID card or other document by gripping it with the friction coatings 12 on the thumb 14 and forefinger 15, such that the LEDs 11 are directed toward the security indicator on the document.

The glove 10 is preferably manufactured from a durable, flexible fabric which is easily cleaned, such as cotton or a cotton-rayon blend. The LEDs 11, the on/off switch 16, and the battery compartment 13 are preferably manufactured from rigid, durable materials, such as plastic, steel, and acrylic polymer. The wires are preferably manufactured from braided copper alloy wire sheathed in plastic. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An identity check glove, comprising:
(a) a glove member;
(b) said glove member comprising a palm section connected to a back section;
(c) said back section and said palm section creating an open end;
(d) said open end forming a wrist section;
(e) said glove member further comprising a plurality of finger sections and a thumb section;
(f) said plurality of finger sections and said thumb section extending upwardly from said palm section and said back section such that said glove member is wearable;
(g) a plurality of light emitting diodes mounted to said thumb section;
(h) said plurality of light emitting diodes being configured for emitting ultra-violate light; and
(i) a power supply in electrical communication with said plurality of light emitting diodes.

2. The identity check glove of claim 1 wherein said plurality of finger sections and said thumb section have open ends.

3. The identity check glove of claim 1 wherein one of said plurality of finger sections is an index finger section, and wherein said thumb section and said index finger section have a friction coating.

4. The identity check glove of claim 1 further comprising a pressure activated on/off switch; said pressure activated on/off switch being electrically connected to and configured for controlling said plurality of light emitting diodes.

5. The identity check glove of claim 4 wherein said pressure activated on/off switch is located on said thumb section adjacent to said plurality of light emitting diodes.

6. The identity check glove of claim 1 further comprising a battery compartment; said battery compartment being located within said wrist section.

7. The identity check glove of claim 1 wherein said power supply comprises one or more replaceable batteries.

8. The identity check glove of claim 1 wherein said glove member is constructed from a durable, flexible fabric material.
